(19) United States
(12) Patent Application Publication
(10) Pub. No.: US 2007/0027595 A1
(43) Pub. Date: Feb. 1, 2007

(54) TELEMATICS SYSTEM USING HOME NETWORK SYSTEM AND CONTROL METHOD THEREOF

(76) Inventor: Seong Taeg NOU, Icheon-Shi (KR)

Correspondence Address: IPLA P.A., 3580 WILSHIRE BLVD., 17TH FLOOR, LOS ANGELES, CA, 90010, US

(21) Appl. No.: 11/428,259

(22) Filed: Jun. 30, 2006

(30) Foreign Application Priority Data
Jul. 26, 2005 (KR) 10-2005-0067619

(51) Int. Cl. G06F 17/00

(52) U.S. Cl. 701/36; 701/1; 340/426.1

(57) ABSTRACT

A telematics system using a home network system and a control method thereof are provided. The telematics system includes: a home server for receiving a vehicle information signal, and transmitting a vehicle control signal; a home network center for receiving and transmitting the vehicle control signal, and receiving and transmitting the vehicle information signal; a telematics service center for receiving and transmitting the vehicle control signal, receiving and transmitting the vehicle information signal,; and a telematics terminal for receiving the vehicle control signal, confirming a variety of vehicle information, generating a vehicle information signal having the vehicle information, and again transmitting the generated vehicle information signal.

### BACKGROUND OF THE INVENTION

1. Field of the Invention

The present invention relates to a telematics system using a wire and wireless communication network including a mobile communication network and an Internet network, and more particularly, to a telematics system using a home network system and a control method thereof, for allowing a user to connect to a vehicle terminal through a home network system, thereby not only performing a video communication but also directly monitoring interior and peripheral circumstances of a vehicle, and confirming a variety of vehicle information and controlling a vehicle function.

2. Description of the Related Art

In recent years, a telematics being one of technologies attracting attention is a compound word of telecommunication and informatics, and refers to an integrated information system based on a car.

Such a telematics system is a vehicle multimedia service system that detects vehicle state information and occurrence of a variety of vehicle accidents using a wire and wireless communication network having a mobile communication network and an Internet network, guides a vehicle running path using a global positioning system (GPS), and provides a vehicle driver with a variety of other information such as traffic information, remote vehicle diagnosis, and countermeasure to an emergency situation, and provides a vehicle fellow passenger with an infortainment service such as Internet, movie, and game.

One of the reasons why the telematics system attracts attention is that it creates a newly conceptive value added service, which is able to maximize a synergy effect by merging an automobile industry and an Information Telecommunication (IT) industry regarded as different industries up to now. Accordingly, a standardization group of telematics is provided. In the standardization group, there are being standardized an operation and a function of each constituent part of the telematics system, a communication protocol between the constituent parts, and services using a communication network.

Together with the spotlight of a telematics technology and the development of the telematics system, a variety of service contents satisfying a user's desire are being required.

### SUMMARY OF THE INVENTION

Accordingly, the present invention is directed to a telematics system using a home network system and a control method thereof that substantially overcome one or more of the limitations and disadvantages of the conventional art.

One object of the present invention is to provide a telematics system using a home network system and a control method thereof, for allowing a user at a home to connect to a telematics terminal installed at a remote vehicle, through a home network system terminal, thereby providing services of monitoring of vehicle peripheral circumstance, video communication, remote vehicle diagnosis, remote vehicle control, and vehicle position confirmation.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a telematics system using a home network system in a wire and wireless communication network that has a mobile communication network and an Internet network, the telematics system including: a home server for receiving a vehicle information signal from a vehicle through an Internet network depending on a key pressed by a user, and transmitting a vehicle control signal to the vehicle; a home network center for receiving the vehicle control signal from the home server, transmitting the received vehicle control signal to a telematics service center through the Internet network, receiving the vehicle information signal from the telematics service center in response to the vehicle control signal, and transmitting the received vehicle information signal to the home server; the telematics service center for receiving the vehicle control signal from the home network center, transmitting the received vehicle control signal to a telematics terminal installed within the vehicle, through the mobile communication network, receiving the vehicle information signal from the telematics service center in response to the vehicle control signal, and transmitting the received vehicle information signal to the home network center through the Internet network; and the telematics terminal for receiving the vehicle control signal from the home server, confirming a variety of vehicle information depending on the received vehicle control signal, generating a vehicle information signal having the vehicle information, and again transmitting the generated vehicle information signal to the home server.

In another aspect of the present invention, there is provided a control method of a telematics system using a home network system that has a home server, a home network center, a telematics service center, and a telematics terminal, the method including the steps of: upon reception of a user's request for a vehicle control service, in the home server, generating and transmitting a vehicle control signal; in the home network center, receiving the vehicle control signal, and transmitting the received vehicle control signal to the telematics service center through an Internet network; in the telematics service center, receiving the vehicle control signal from the home network center, and transmitting the vehicle control signal to the telematics terminal through a mobile communication network; in the telematics terminal, receiving the vehicle control signal, executing a control command of the home server, generating a vehicle information signal corresponding to the vehicle control signal, and transmitting the generated vehicle information signal to the telematics service center through the mobile communication network; upon reception of the vehicle information signal in response to the vehicle control signal, in the telematics service center, transmitting the vehicle information signal to the home network center through the Internet network; upon reception of vehicle information signal in response to the vehicle control signal, in the home network center, transmitting the vehicle information signal to the home server; and upon reception of the vehicle information signal in response to the vehicle control signal, in the home server, informing the user.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a schematic construction of a telematics system using a home network system according to an embodiment of the present invention;

FIG. 2 is a block diagram illustrating a construction of a telematics terminal according to an embodiment of the present invention; and

FIG. 3 is a process diagram illustrating an operation of a telematics system according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

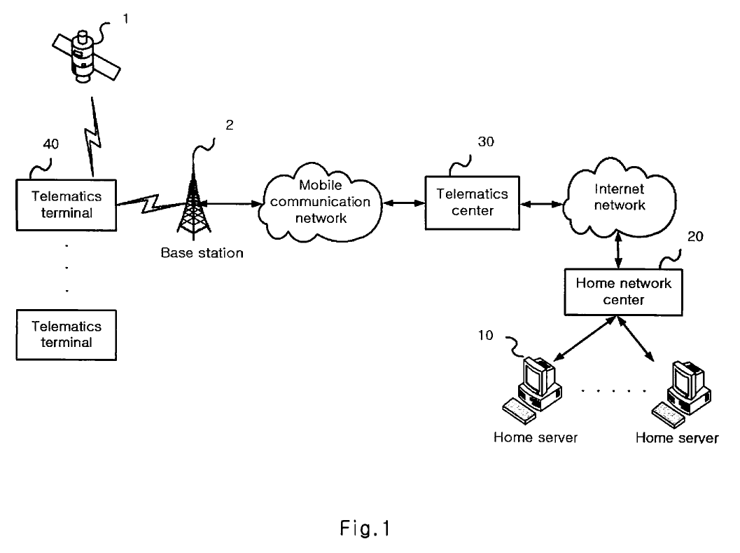

FIG. 1 illustrates a schematic construction of a telematics system using a home network system according to an embodiment of the present invention.

The inventive telematics system includes a home server 10, a home network center 20, a telematics service center 30, a telematics terminal 40, and a wire and wireless communication network including an Internet network and a mobile communication network.

The home server 10 is a key equipment of a home network system, for integrating and integrally controlling home appliances and information equipments, such as a personal computer, a television set, an audio set, a telephone, and a lighting equipment, as one network, and connecting with a very high speed of external Internet network, and easily controlling the home appliances and information equipments through a portable terminal at the exterior. In addition to the above functions, the home server 10 further includes a function of receiving a vehicle information signal from a remote vehicle through the Internet network depending on a key pressed, and transmitting a vehicle control signal to the vehicle.

The vehicle control signal includes a variety of control signals corresponding to a camera control command for driving and controlling a plurality of digital cameras installed at the internal and external of the vehicle; a vehicle remote diagnosis command for diagnosing a variety of vehicle states such as vehicle damage and theft or not, opening or closing of a door, and opening or closing of a window; a vehicle position confirmation command for confirming an accurate current position of the vehicle; and a video communication command.

In particular, the home server 10 includes map data and therefore, can receive the vehicle position information, that is, a global positioning system (GPS) coordinate value from the vehicle telematics terminal 40, map the GPS coordinate value to the map data, and allow the user to directly view the accurate current position of the vehicle through a monitor of the home server 10.

The home network center 20 is connected to a plurality of the home servers 10 distinguished on a housing complex and area basis, and is connected to the telematics service center 30 through the Internet network. The home network center 20 receives the vehicle control signal from the home server 10 and transmits the received vehicle control signal to the telematics service center 30, and receives the vehicle information signal from the telematics service center 30 in response to the vehicle control signal and transmits the received vehicle information signal to the home server 10.

The telematics service center 30 is connected with the vehicle telematics terminal 40 through the mobile communication network, and is connected with the home network center 20 through the Internet network. The telematics service center 30 receives the vehicle control signal from the home network center 20 and transmits the received vehicle control signal to the vehicle telematics terminal 40, and receives the vehicle information signal from the telematics service center 30 in response to the vehicle control signal and transmits the received vehicle information signal to the home network center 20.

The telematics service center 30 stores an authentication code of the home server 10 user and a registration number of the telematics terminal 40 and therefore, upon reception of the vehicle control signal from the home server 10, the telematics service center 30 requests the home server 10, which transmits the vehicle control signal through the home network center 20, for authentication, and upon reception of an authentication code in response to the authentication request, the telematics service center 30 compares the received authentication code with the previously stored authentication code, and performs the authentication.

The telematics terminal 40 is installed at the vehicle, and receives the vehicle control signal from the home server 10 via the home network center 20 and the telematics service center 30, confirms a variety of vehicle information depending on the received vehicle control signal, generates the vehicle information signal having the vehicle information, and again transmits the generated vehicle information signal to the home server 10.

The vehicle information signal transmitted from the telematics terminal 40, includes at least one of vehicle periphery image information obtained by photographing a vehicle periphery using a plurality of digital cameras 5 installed at the internal and external of the vehicle; video communication image information; a variety of vehicle state information such as the vehicle damage and theft or not, the opening or closing of the door, and the opening or closing of the window; and the vehicle position information including the GPS coordinate value of the vehicle received from an artificial satellite 1.

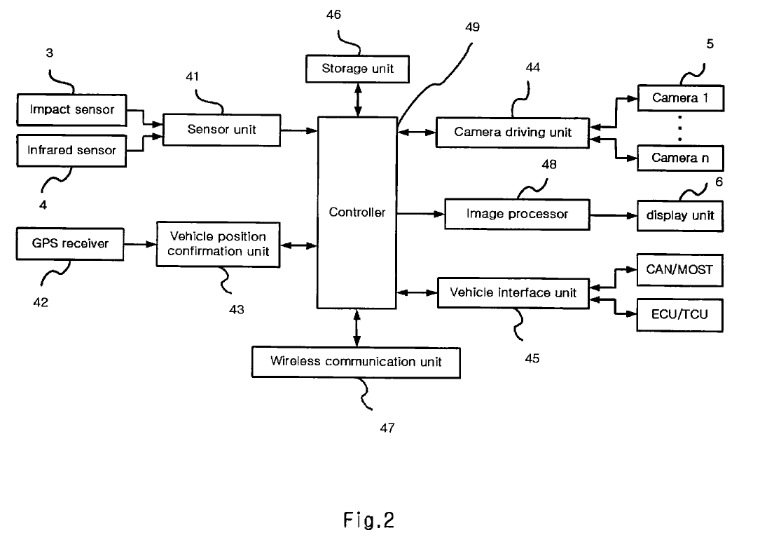

FIG. 2 is a block diagram illustrating a construction of the telematics terminal according to an embodiment of the present invention.

The telematics terminal 40 includes a sensor unit 41, a GPS receiver 42, a vehicle position confirmation unit 43, a camera driving unit 44, a vehicle interface unit 45, a storage unit 46, a wireless communication unit 47, an image processor 48, and a controller 49.

The sensor unit 41 includes a plurality of sensors 3 and 4 installed at the external and internal of the vehicle, and receives measurement values from the sensors 3 and 4 and generates an impact sense signal for impact applied to the vehicle and an intrusion sense signal for intrusion of an outsider

The GPS receiver 42 receives satellite position confirmation signals from a plurality of artificial satellites 1.

The vehicle position confirmation unit 43 calculates the vehicle position coordinate value from the signal received from the GPS receiver 42, maps the coordinate value to the map data of the storage unit 46, and generates the current vehicle position information.

The camera driving unit 44 controls operations of the plurality of digital cameras installed at the external and internal of the vehicle, receives image signals from the digital cameras 5, and generates the vehicle periphery image information.

The vehicle interface unit 45 is connected with a vehicle network system or a vehicle controller, and receives the vehicle state information or transmitting the vehicle control information.

The storage unit 46 temporarily or lastingly stores a variety of control programs for activating the telematics terminal 40, the map data, the vehicle position information, the vehicle state information, and the vehicle image information.

The wireless communication unit 47 is connected with the home server 10 through the Internet network or the mobile communication network, and receives the vehicle control signal from the home server 10 and transmits a vehicle position information signal, a vehicle state information signal, and a vehicle image information signal, to the home server 10.

The image processor 48 displays the vehicle position information, the vehicle state information, and the vehicle image information through a liquid crystal display.

The controller 49 takes charge of a general control of the telematics terminal 40 comprised of the constituent elements.

Specifically, the sensor unit 41 is comprised of the impact sensor 3 for sensing the impact applied to the vehicle from the exterior, and an infrared human-body sensor for sensing outsider's approach or intrusion to the vehicle.

The vehicle interface unit 45 is connected with the vehicle network system such as a car area network (CAN) that takes charge of a general power train of the vehicle and a media oriented system transport (MOST) for controlling all multimedia-related systems such as vehicle digital versatile disk (DVD), radio, amplifier (AMP), and CDC and controlling image and sound reproduced. Or, the vehicle interface unit 45 is directly connected with the vehicle controller of an electronic control unit (ECU) and a transmission control unit (TCU) of the vehicle, and diagnoses or controls the vehicle states of a variety of multimedia equipments, the car door, a trunk, a hood, and the window.

The wireless communication unit 47 can connect the telematics terminal 40 to the mobile communication network or the Internet network, and can employ various communication methods such as a code division multiple access (CDMA)(cellular), a dedicated Short-Range communication (DSRC)(Communication Air-interface Long and Medium range: CALM), a wireless local area network (WLAN), and a digital multimedia broadcasting (DMB). It is rather effective than a single communication method employing any one of the above methods, to organically combine and use a characteristic of each communication method so that a high speed mobility and an all-direction networking function of the vehicle can be preferably supported.

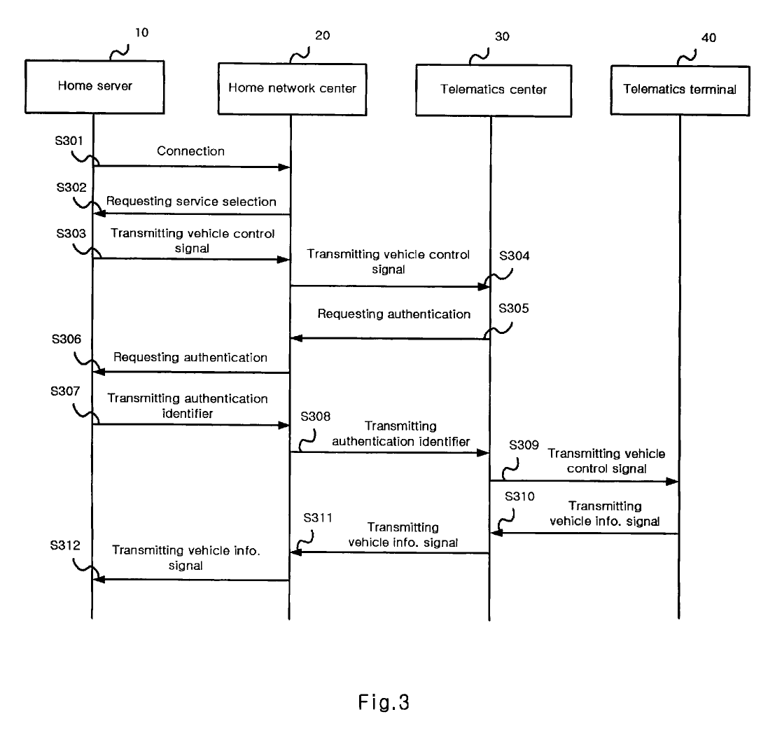

FIG. 3 is a process diagram illustrating an operation of the telematics system according to an embodiment of the present invention.

An operation of the above-constructed telematics system will be in detail described with reference to FIGS. 1 to 3 below.

First, the home server 10 user and the corresponding telematics terminal 10 should be in a state of being subscribed to a remote vehicle control service of the telematics service center 30. The telematics service center 30 stores inherent authentication code data, which is necessary for authentication upon user's request of the vehicle control service, and the registration number of the telematics terminal 40. In general, the inherent authentication code can employ an identifier and a password.

First, if the home server 10 is connected to the home network center 20 through the Internet network depending on the key pressed by the user (Step 301), the home network center 20 displays a vehicle control service menu screen on the monitor of the home server 10, and requests the user for service selection (Step 302).

After that, if the user selects his/her desiring service menu screen, the home server 10 generates and transmits the vehicle control signal to the home network center 20 (Step 303). The home network center 20 receives the vehicle control signal from the home server 10, and again connects to the telematics service center 30 through the Internet network and transmits the vehicle control signal to the telematics service center 30 (Step 304).

If the telematics service center 30 receives the vehicle control signal from the home network center 20, it requests the home server 10 for the authentication code through the home network center 20 (Steps 305 and 306). The home server 10 transmits an authentication identifier such as the identifier and the password, to the telematics service center 30 through the home network center 20 (Steps 307 and 308).

After that, the telematics service center 30 compares the authentication code included in the authentication identifier received from the user, with the previously stored authentication code, and determine a service subscriber or not. If it is determined to be the service subscriber, the telematics service center 30 transmits the vehicle control signal to the telematics terminal 40 of the vehicle through the mobile communication network (Step 309).

Next, the telematics terminal 40 receives the vehicle control signal, executes a control command of the home server 10, generates the vehicle information signal corresponding to the vehicle control signal, and transmits the generated vehicle information signal to the telematics center 30 through the mobile communication network (Step 310). Upon reception of the vehicle information signal in response to the vehicle control signal, the telematics service center 30 transmits the vehicle information signal to the home server 10 via the home network center 20 through the Internet network (Steps 311 and 312).

Upon reception of the vehicle information signal in response to the vehicle control signal, the home server 10 outputs a variety of service result screens included in the vehicle information signal, to the user through the monitor of the home server 10.

Accordingly, the user can activate the cameras installed at the internal and external of the remote vehicle, monitor the periphery circumstances at the home through the monitor of the home server 10, and diagnose and directly control the opening or closing of the door, the window, the hood, and the trunk, and the variety of vehicle states.

Further, the user can confirm the accurate current position of the vehicle and a real-time running path through the monitor of the home server 10, using the vehicle position information received from the vehicle, that is, the GPS coordinate value and the map data previously stored in the home server 10 and in addition, can realize a real-time video communication with a current vehicle driver.

As described above, the present invention has an advantage in that since the user can receive the vehicle information from the remote place and directly control the vehicle through the monitor of the home server 10 at the home, he/she can quickly and easily cope with emergency circumstance such as the vehicle theft and damage without paying attention to time and place.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A telematics system using a home network system in a wire and wireless communication network that has a mobile communication network and an Internet network, the telematics system comprising:
a home server for receiving a vehicle information signal from a vehicle through the Internet network depending on a key pressed by a user, and transmitting a vehicle control signal to the vehicle;
a home network center for receiving the vehicle control signal from the home server, transmitting the received vehicle control signal to a telematics service center through the Internet network, receiving the vehicle information signal from the telematics service center in response to the vehicle control signal, and transmitting the received vehicle information signal to the home server;
the telematics service center for receiving the vehicle control signal from the home network center, transmitting the received vehicle control signal to a telematics terminal installed within the vehicle, through the mobile communication network, receiving the vehicle information signal from the telematics service center in response to the vehicle control signal, and transmitting the received vehicle information signal to the home network center through the Internet network; and
the telematics terminal for receiving the vehicle control signal from the home server, confirming a variety of vehicle information depending on the received vehicle control signal, generating a vehicle information signal having the vehicle information, and again transmitting the generated vehicle information signal to the home server.

2. The system according to claim 1, wherein the telematics terminal comprises:
a sensor unit having a plurality of sensors installed at the external and internal of the vehicle, and receiving measurement values from the sensors and generating an impact sense signal for impact applied to the vehicle and an intrusion sense signal for intrusion of an outsider;
a GPS receiver for receiving satellite position confirmation signals from a plurality of artificial satellites;
a vehicle position confirmation unit for receiving the satellite position confirmation signals from the GPS receiver, calculating a vehicle position coordinate value from the received signals, mapping the coordinate value to map data of a storage unit, and generating current vehicle position information;
a camera driving unit for controlling operations of a plurality of digital cameras installed at the external and internal of the vehicle, receiving image signals from the digital cameras, and generating vehicle periphery image information;
a vehicle interface unit connected with a vehicle network system or a vehicle controller, and receiving vehicle state information or transmitting vehicle control information;
the storage unit for temporarily or lastingly storing a variety of control programs for activating the telematics terminal, the map data, the vehicle position information, the vehicle state information, vehicle image information;
a wireless communication unit connected with the home server through the Internet network or the mobile communication network, and receiving the vehicle control signal from the home server, and transmitting a vehicle position information signal, a vehicle state information signal, and a vehicle image information signal to the home server;
an image processor for displaying the vehicle position information, the vehicle state information, and the vehicle image information through a liquid crystal display; and
a controller for performing a general control of the telematics terminal.

3. The system according to claim 2, wherein the sensor unit has an impact sensor for sensing impact applied to the vehicle from the exterior.

4. The system according to claim 2, wherein the sensor unit has an infrared human-body sensor for sensing outsider's approach or intrusion to the vehicle.

5. The system according to claim 2, wherein the vehicle interface unit is connected with a CAN (car area network) taking charge of a general power train of the vehicle, and a MOST (media oriented system transport) for controlling all vehicle multimedia-related systems and controlling image and sound reproduced.

6. The system according to claim 2, wherein the vehicle interface unit is directly connected with the vehicle controller such as an ECU (electronic control unit) and a TCU (transmission control unit) of the vehicle, and is constructed such that the controller can diagnose or control vehicle states of a variety of multimedia equipments, a car door, a trunk, a hood, and a window.

7. The system according to claim 1, wherein the home server further comprises map data, and receives the vehicle position information from the telematics terminal, maps the received vehicle position information to the map data, and displays the mapped vehicle position information to the user.

8. The system according to claim 1, wherein the vehicle information signal comprises at least one of vehicle periphery image information, video communication image information, vehicle state information, and vehicle position information.

9. The system according to claim 1, wherein the vehicle control signal comprises at least one control command of a camera control command, a vehicle remote diagnosis command, a vehicle position confirmation command, and a video communication command.

10. A control method of a telematics system using a home network system that has a home server, a home network center, a telematics service center, and a telematics terminal, the method comprising the steps of:
upon reception of a user's request for a vehicle control service, in the home server, generating and transmitting a vehicle control signal;
in the home network center, receiving the vehicle control signal, and transmitting the received vehicle control signal to the telematics service center through an Internet network;
in the telematics service center, receiving the vehicle control signal from the home network center, and transmitting the vehicle control signal to the telematics terminal through a mobile communication network;
in the telematics terminal, receiving the vehicle control signal, executing a control command of the home server, generating a vehicle information signal corresponding to the vehicle control signal, and transmitting the generated vehicle information signal to the telematics service center through the mobile communication network;
upon reception of the vehicle information signal in response to the vehicle control signal, in the telematics service center, transmitting the vehicle information signal to the home network center through the Internet network;
upon reception of vehicle information signal in response to the vehicle control signal, in the home network center, transmitting the vehicle information signal to the home server; and
upon reception of the vehicle information signal in response to the vehicle control signal, in the home server, informing the user.

11. The method according to claim 10, wherein the telematics service center stores an authentication code of the home server user and a registration number of the telematics terminal, and upon reception of the vehicle control signal, requests for authentication of the home server, which transmits the vehicle control signal through the home network center, and upon reception of an authentication code in response to an authentication request, compares the received authentication code with the previously stored authentication code, and performs the authentication.
